(19) United States
(12) Patent Application Publication
(10) Pub. No.: US 2007/0299701 A1
(43) Pub. Date: Dec. 27, 2007

(54) EVENT DRIVEN AIRPORT

(75) Inventors: Stanley Gene Boyer, Euless, TX (US); Joseph Robert Offutt, Grapevine, TX (US); Kimberly Patrick Farrow, Eutess, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sabre Inc.

(21) Appl. No.: 11/851,828

(22) Filed: Sep. 7, 2007

Related U.S. Application Data
(62) Division of application No. 09/891,197, filed on Jun. 26, 2001.

(51) Int. Cl. G06Q 50/00

(52) U.S. Cl. 705/5; 705/9

(57) ABSTRACT

A network equipped with methods for detecting and notifying entities of changes in travel information (“events”) to users. In accordance with one aspect of the invention, a method for notifying entities of events comprises the steps allowing an entity to register interest in an event, and providing a means to notify entities when an event occurs, thus allowing a response to the notification. In accordance with another aspect of the invention, a system for notifying entities of events comprises a source system that tracks changes in travel schedules, a publish-and-subscribe technology that publishes events as they occur, and a receiving system that detects publication of events and that may also have the capability of notifying systems incapable of detecting publication that are interested in events.

### CROSS-REFERENCE TO RELATED APPLICATIONS

This application is a divisional of U.S. application Ser. No. 09/891,197, filed Jun. 26, 2001, which is hereby incorporated herein in its entirety by reference.

### DESCRIPTION OF THE INVENTION

1. Field of the Invention

This invention relates to distributing information on a network and, more particularly, to event based methods and systems for distributing travel information.

2. Background of the Invention

The Internet allows businesses to provide individuals with more recent information than allowed by traditional means, such as telephone, television, or newspaper. Individuals, for example, may now use the Internet to check the status of a pending purchase order, a presidential election, or a particular flight.

The Internet, and specifically the World Wide Web (“Web”), simplifies the process for customers to interface with business computers. The architecture of the Internet follows a conventional client-server model. The terms “client” and “server” refer to a computer's general role as either a requester or receiver of data (the client) or as a provider of data (the server). Under the Web environment, Web browsers reside in clients, and specially formatted “Web documents” reside on Internet (Web) servers. Web clients and Web servers may communicate using a protocol called “HyperText Transfer Protocol” (HTTP).

In operation, a browser opens a connection to a server and initiates a request for a document. The server delivers the requested document, commonly in a standard “HyperText Markup Language” (HTML) format. After the document is delivered, the connection is closed. The browser displays the document or performs a function designated by the document.

Every day, an increasing number of individuals and systems use the Internet for commerce and as a continuous source of timely information. For example, when using the Internet to check flight status, a person may formulate a request to a flight status detection service through a Web browser. This service may be associated with an airline directly or a third party that operates in conjunction with the airline to provide updated information. The person's request may include criteria such as the source and destination cities, the scheduled time of departure or arrival, and the flight number. Most often, the person prefers to obtain information on those flights the person has an interest—for example, he or she may have or know someone who has a reservation on a particular flight.

After receiving the request, the flight status detection service determines which scheduled flights match the person's criteria. The detection system then determines the scheduled time of arrival or departure. And finally, the system determines the estimated time of departure or arrival based on the most recently supplied information—for example, a flight has been canceled or will arrive 10 minutes early.

Further, if an individual misses a connecting flight because of delay or some other reason, the individual must wait in line to be rebooked and receive the new flight information.

Although this example is with respect to an individual, systems likewise use the Internet to receive timely information and may automatically respond to new information.

Accordingly, there is a need for a system and method that automatically and conveniently notifies an entity, which may be an individual or a system, of a change in travel information when such a change occurs.

### SUMMARY OF THE INVENTION

Methods, systems, and articles of manufacture consistent with the present invention overcome the shortcomings of existing systems by providing an automated notification process that listens for events matching an entity's criteria and automatically notifies the entity of the event. An event may include but is not limited to a change in travel information, for example a change in scheduled or estimated flight arrival or departure time, a change in arrival or departure gate, a change in baggage claim for a particular flight, a new flight number for a passenger who has been rebooked, or a change in ground crew work schedule. Other examples of an event may be the absence of an event, for example, a bag that had been checked onto a plane is not checked off or is not checked onto its continuation flight, or a ground crew staff member scheduled to work does not arrive at work. An entity may be anything that registers an interest to receive notification of changes in travel information and may include but is not limited to, an individual—for example, a passenger with a reservation, a person who knows someone with a reservation, or a person who would simply like to know the schedule of a flight; a business—for example, an airport restaurant manager who may want to estimate potential business, hotel mangers or car rental agencies that may expect passengers from a particular flight, airport operators who may wish to reschedule ground crew, or airline booking attendants who may need to reschedule passengers who have been delayed or rerouted; an organization; or a system—for example, a system that manages airline reservations, which automatically reschedules flight information for a passenger in response to a detected change in flight information, a system that manages airline catering, which automatically schedules or reschedules meal service and special meals in response to a scheduling conflict such as a cancelled flight, or a system that manages ground crew, which automatically reschedules crew members in response to changes in crew availability because of a rescheduled flight, illness of a crew member, or a different amount of time required to complete a task than estimated.

In accordance with one aspect of the present invention, as embodied and broadly described herein, a method for notifying entities of an event comprises the steps of: allowing an entity to register interest in an event, listening for an event, notifying the entity of an event upon occurrence and initiating a response to the notification, and transmitting to a second entity notification of the event and initiating a further response to the occurrence of the event.

In accordance with another aspect of the present invention, as embodied and broadly described herein, a method for notifying entities of changes in travel-related events comprises the steps of: allowing an entity to register interest in a travel-related event, notifying the entity upon occurrence of the event and initiating a response to the notification, and automatically transmitting to a second entity notification of the travel-related event initiating a further response to the occurrence of the event.

Additional objects and advantages of the invention will be set forth in part in the description that follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings,

FIG. 1 is a pictorial diagram of a computer network in which systems consistent with the present invention may be implemented;

FIG. 2 is a detailed diagram of a computer network containing a client system and a server system;

FIG. 3 is a flowchart of an exemplary embodiment of the invention;

FIG. 4 is an illustration of a request form used in an exemplary embodiment of the invention;

FIGS. 5A and 5B are illustrations of a Gantt chart, which is monitored by a source system for changes in an exemplary embodiment of the invention;

FIGS. 6A and 6B are illustrations of a flight operator's control board that displays ground crew schedule in an exemplary embodiment of the invention;

FIG. 7A and 7B are illustrations of a notification sent to a cellular telephone used in an exemplary embodiment of the invention;

FIG. 8 is an illustration of a notification sent to an electronic pager device used in an exemplary embodiment of the invention; and

FIG. 9 is a flowchart of an exemplary embodiment of the present invention.

### DETAILED DESCRIPTION

Reference will now be made in detail to an implementation consistent with the present invention as illustrated in the accompanying drawings. Wherever possible, the same reference numbers will be used throughout the drawings and the following description to refer to the same or like parts.

Systems and methods consistent with the present invention provide a network for distributing travel information to entities and notifying entities of an event, such as changes to a flight schedule. The event may be determined using criteria supplied in the registration request. Examples of events include but are not limited to the following: an individual may request notification of changes in a particular flight and notification in case the individual is rebooked on a different flight; an airport restaurant owner may request notification for changes in all flights; an airport operator or system may request notification if any flight has a change in status of 30 minutes or more or if a ground crew staff member has not appeared for work, which may allow for automatic rescheduling of ground crew; an airline operator or system may request notification that a passenger has checked-in for a flight but not boarded, which may allow for automatic rebooking of boarded passengers; an airline operator or system may request notification that a checked bag was not detected at a destination airport or was not checked in to a connecting flight, which may allow for immediate tracing and locating of the missing luggage; a fuel operator or system may request notification of changes in flight arrivals, which may allow for automatic notification that a plane requires refueling at a certain time, or that the fuel service must order additional fuel because of an unexpected increase in consumption; or a catering coordinator or system may request notification of flight changes that results in changes to meal orders, which allows for automatic update to available meals on a given flight (e.g., an individual who placed a vegetarian order may have been rebooked on different flight and the vegetarian meal will then be transferred to the different flight).

The network, used in accordance with the principles of the present invention, notifies the entity of any changes in travel information according to the entity's request, which initiates a response to the notification. At least one additional event results from the response, notification of which is transmitted to a second entity. Further, this system and method allow entities to continuously receive travel information with a single request. Entities can subscribe to the network such that changes to the travel information are automatically received and presented to the entity.

Publish and subscribe technology provides tools and infrastructure for publishing and subscribing to events. For example, a publish and subscribe system may track the scheduled departure and arrival time of flights. If a flight reports a delay, the event driven technology will be triggered and will send notification to those entities that have made a request. Software components are incorporated into the publishing applications and receiving applications, which allows them to interact with the network and each other. An additional component may be a notification service that distributes data to entities via a designated device. This may be done through a device independent server that translates a data/message to any type of device.

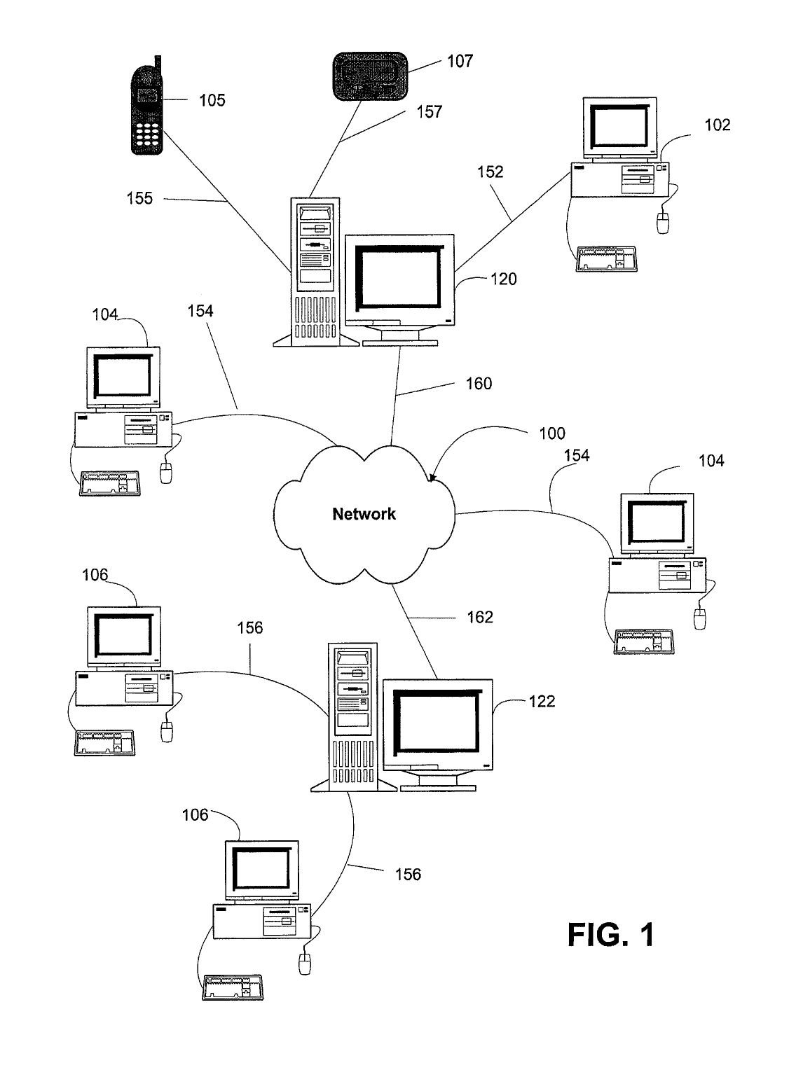

FIG. 1 illustrates a conceptual diagram of a computer network 100, such as the Internet. Computer network 100 comprises client computers (such as computers 102, 104, and 106), server computers (such as servers 120 and 122), and other transmitters and receivers of electronic data (such as cellular telephones 105, electronic paging devices 107, and hand-held computers, not shown). Commonly, client computers are “personal computers” or workstations and are the sites where a human user operates the computer to request data from other computers or servers on the network. Commonly, the requested data resides in server computers.

In this specification, the terms “client” and “server” are used to refer to a computer's general role as a requester and/or receiver of data (a client) or a provider of data (a server). In general, the size of a computer or the resources associated with it do not preclude the computer's ability to act as a client or a server. Further, each computer may request data in one transaction and provide data in another transaction, thus changing the computer's role from client to server, or vice versa.

Client computers, server computers, and other transmitters and receivers of electronic data are coupled to network 100 via a link (e.g., 152, 155, 157, and 160). The link may be, for example, a phone line, an Ethernet connection, or a wireless technology.

A client, such as computer 102, may request a file from server 120. If client 102 is directly connected to server 120, for example through a local area network, this request would not normally result in a transfer of data over what is shown as network 100. The network 100 represents, for example, the Internet, which is an interconnection of networks. Although this specification will refer to a “network” as an interconnection of networks, a network is simply a connection of two or more computers with the ability to transfer data between or among them. Although the invention is described with respect to an interconnection of networks, it is equally applicable to a connection of two or more computers. While FIG. 1 depicts network 100 as a single network comprised of a plurality of computers, it is understood that the size of the network 100 may be significantly larger and may comprise a plurality of interconnected computers.

A different request from computer 102 may be for a file that resides in server 122. In this case, the data are transferred from server 122 through network 100 to server 120 and, finally, to computer 102. The distance between server 120 and server 122 may be very long, e.g., across continents, or very short, e.g., within the same city. Further, in traversing the network the data may be transferred through several intermediate servers and many routing devices, such as bridges and routers.

Some receiving systems have the ability to “listen” and some do not. For purposes of this specification, those systems capable of listening will be referred to as “listening-receiving systems” or “LRS,” and those systems not capable of listening will be referred to as “non-listening-receiving systems” or “N-LRS.” Although reference is made to a “receiving system,” this in no way limits the invention to include systems solely with the capability of receiving information. Rather, the invention comprises systems that at least have the capability to receive information. In addition, although a distinction is made between devices including and not including the ability to listen, one skilled in the art will recognize that the distinction may not be relevant in all possible embodiments.

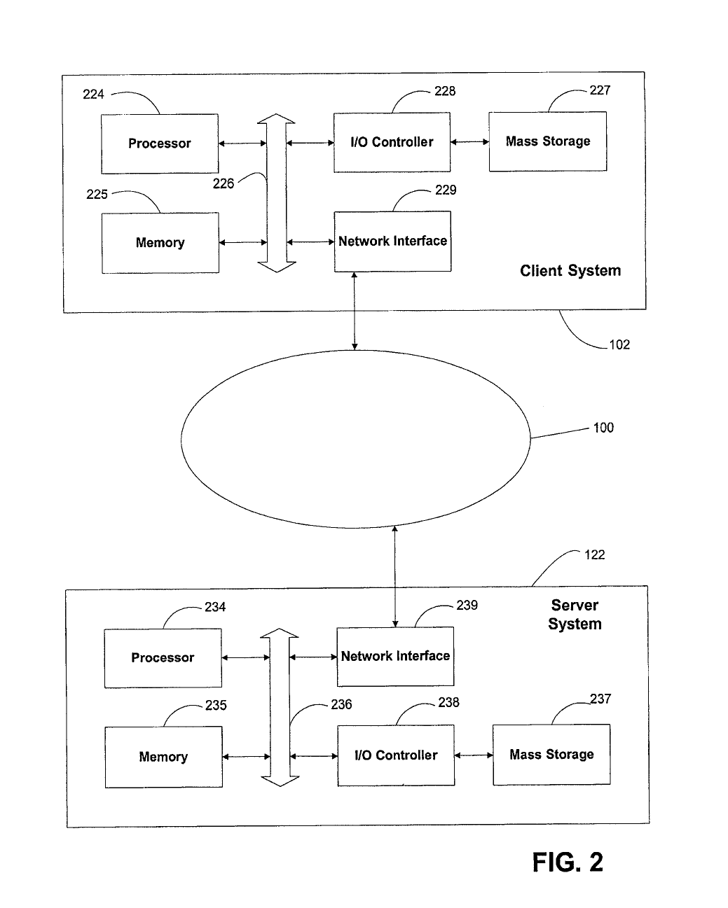

FIG. 2 shows, in more detail, an example of a client-server system interconnected through network 100. In this example, a server system 122 is interconnected through network 100 to client system 102. Client system 102 includes conventional components such as a processor 224, memory 225 (e.g., RAM), a bus 226 that couples processor 224 and memory 225, a mass storage device 227 (e.g., a magnetic hard disk or an optical storage disk) coupled to processor 224 and memory 225 through an I/O controller 228, and a network interface 229, such as a conventional modem.

Server system 122 also includes conventional components such as a processor 234, memory 235 (e.g., RAM), a bus 236 that couples processor 234 and memory 235, a mass storage device 237 (e.g., a magnetic or optical disk) coupled to processor 234 and memory 235 through an I/O controller 238 and a network interface 239, such as a conventional modem. It will be appreciated from the description below that the present invention may be implemented in software that is stored as executable instructions on a computer readable medium on the client and server systems, such as mass storage devices 227 and 237 respectively or in memories 225 and 235 respectively.

One skilled in the art will recognize that many executions and memory schemes can be used to implement the present invention. In addition, single or multiple computer systems may also be used in the implementation of the present invention. In one embodiment, the components are executed and contained within a single computer's memory. This memory may be RAM, ROM, other memory structure, or a combination thereof. However, this invention may also be implemented using virtual memory, a secondary storage medium, and/or across multiple computers. These various configuration issues relate to an implementation preference and are considered within the scope of the present invention.

While the network described with respect to FIGS. 1 and 2 references a network, and specifically the Internet, it will be recognized by one skilled in the art that the network may be any topology, including private networks and internal computer structures, that allows either various computer systems or modules within a single computer system to exchange information.

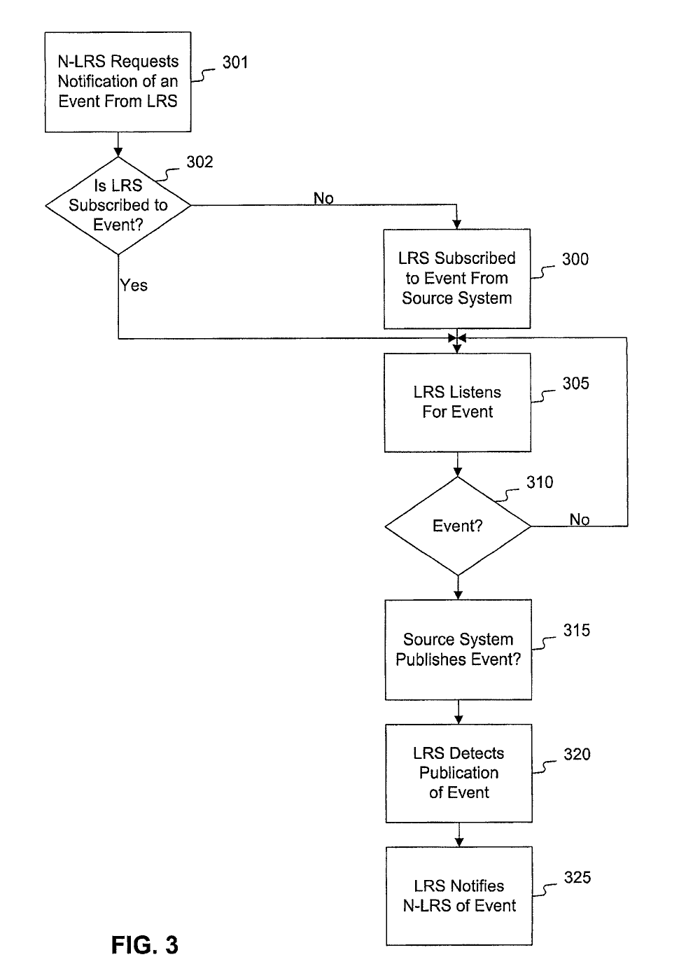

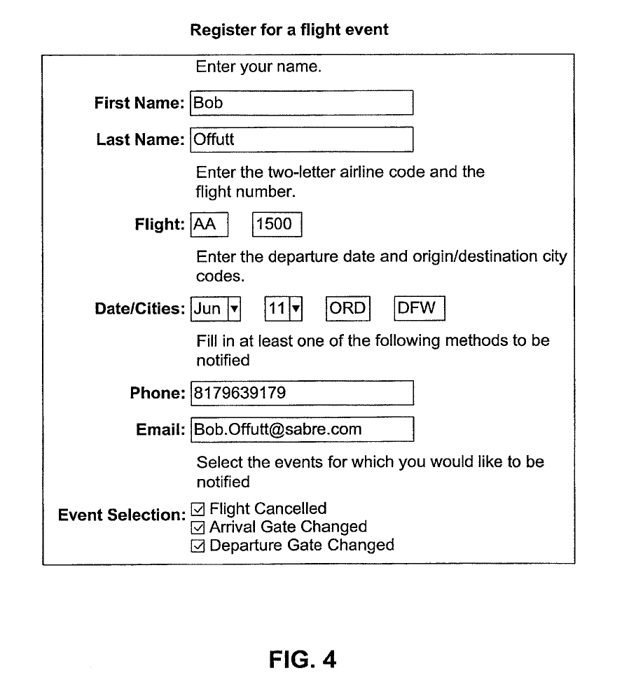

FIG. 3 is a detailed flowchart of a possible embodiment of the invention. The invention starts with an N-LRS requesting notification of an event (step 301). This request is transmitted to an LRS. This could be, for example, an individual requesting notification that a flight will be delayed or possible rebooking information from an LRS that provides such information. There are many possible formulations to make such a request. FIG. 4 demonstrates an exemplary format. Relevant criteria may be provided in making the initial request. The request from the N-LRS could include such information as a change in arrival time of a particular flight, whether an individual is rebooked on an alternate connecting flight, the arrival time of all flights into it a particular airport, a change in baggage claim, etc. This request may also be made using various formats, including but not limited to completing a form similar to the exemplary form in FIG. 4, contacting an individual via telephone or other means who processes the requested data, or contacting a voice recognition device.

One skilled in the art will recognize that an LRS may also transmit a request for notification of an event to another LRS.

After the LRS has received the request, the LRS might determine whether it is already subscribed to the event (step 302). This step may be used to prevent duplicate requests. If the LRS determines it is not subscribed, it will proceed to step 300. If the LRS is subscribed, it will proceed to step 305.

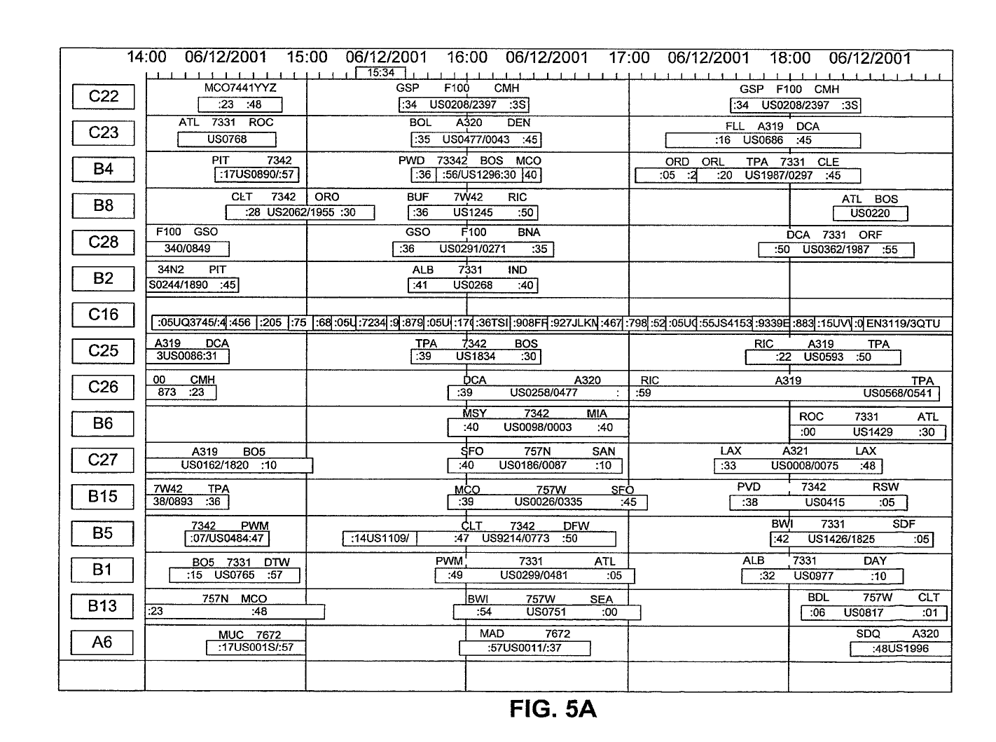

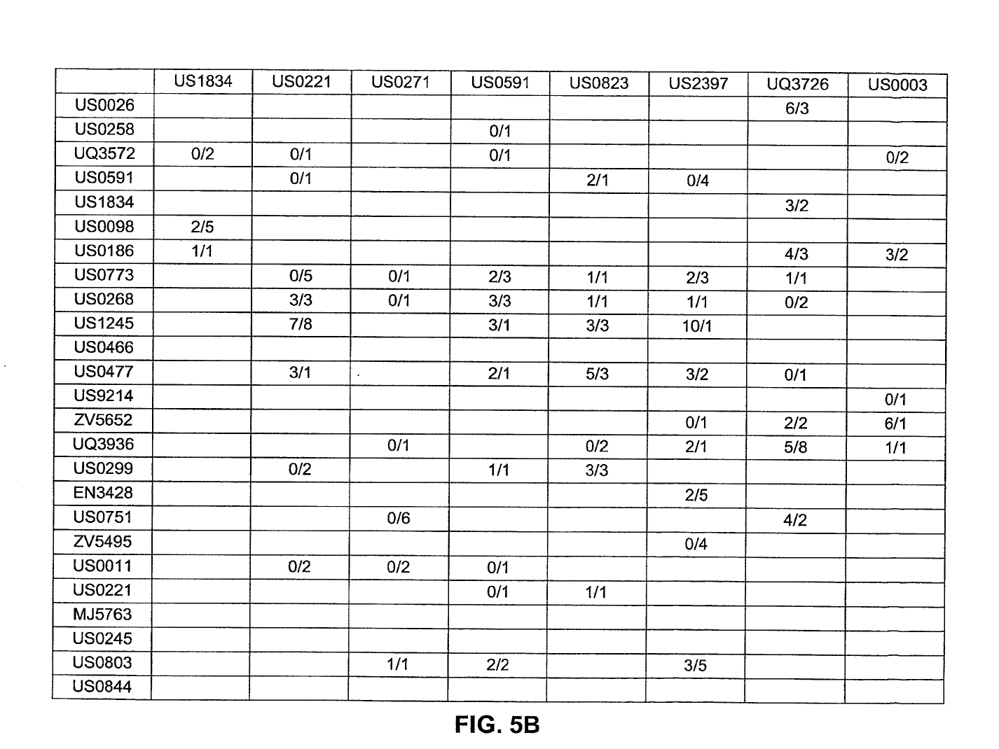

If the LRS determines that it is not subscribed to a desired event, the LRS subscribes to the desired event (step 300). This is accomplished by transmitting a request to the source system including relevant parameters. A source system publishes information that has changed states (i.e., an event). For example, FIGS. 5a and 5b are examples of a Gantt chart for departure and arrival of airplanes. Such a chart is updated as new information is received—for example, notification a flight is delayed. A source system monitors the chart for any such changes in information and publishes all such changes.

One skilled in the art will recognize that an LRS may subscribe to a source system independent of any request from an N-LRS. In such a scenario, for example, and airline operator may be an LRS and desire notification of changes in flight status. In this instance, the airline operator need not await a request from an N-LRS to subscribe to an event.

A request from an N-LRS may differ from a request from an LRS. For example, the N-LRS request may include requests for individualized information, such as a person has been rebooked on a particular flight. The LRS request will typically be for generic information, such as a flight is delayed or a baggage claim has changed for an entire flight. If the N-LRS requests individualized information, the LRS may request the generic component of the N-LRS request, and process the individualized request independently. For example, if an N-LRS requests notification of changes of flight UA 109 and connecting flight UA 200, the LRS will request events relating to flights UA 109 and UA 200. If the LRS receives notification that passengers on UA 109 will miss connecting flight UA 200, the LRS may send notification to an airline operating system, which may then rebook passengers and notify the LRS and/or N-LRS of the updated information, i.e., the new connecting flight information. The LRS may then inform the NLRS of the individualized information, if the information has not already been transmitted.

Once the LRS has subscribed to an event, the LRS listens for the event (step 305). The source system will publish all events, and the LRS may detect publication of those events to which it has subscribed. For example, the source system may publish the event “UA 732 delayed 45 minutes.” If the LRS subscribes to events relating to UA 732, it will detect this event. If it subscribes to UA 123 but not UA 732, it will not detect the event.

If an event does not occur, the LRS will simply continue to listen (step 310); however, if an event occurs, the source system will publish the event using a publish and subscribe technology, such as Prism made by PrismTech, located in the United Kingdom, TIBCO made by TIBCO Software Inc., located in Palo Alto, Calif., or MQSeries made by I.B.M., located in Armonk, N.Y (step 315). Accordingly, an event is published upon occurrence. Once the event has been published, the LRS will detect the publication (step 320).

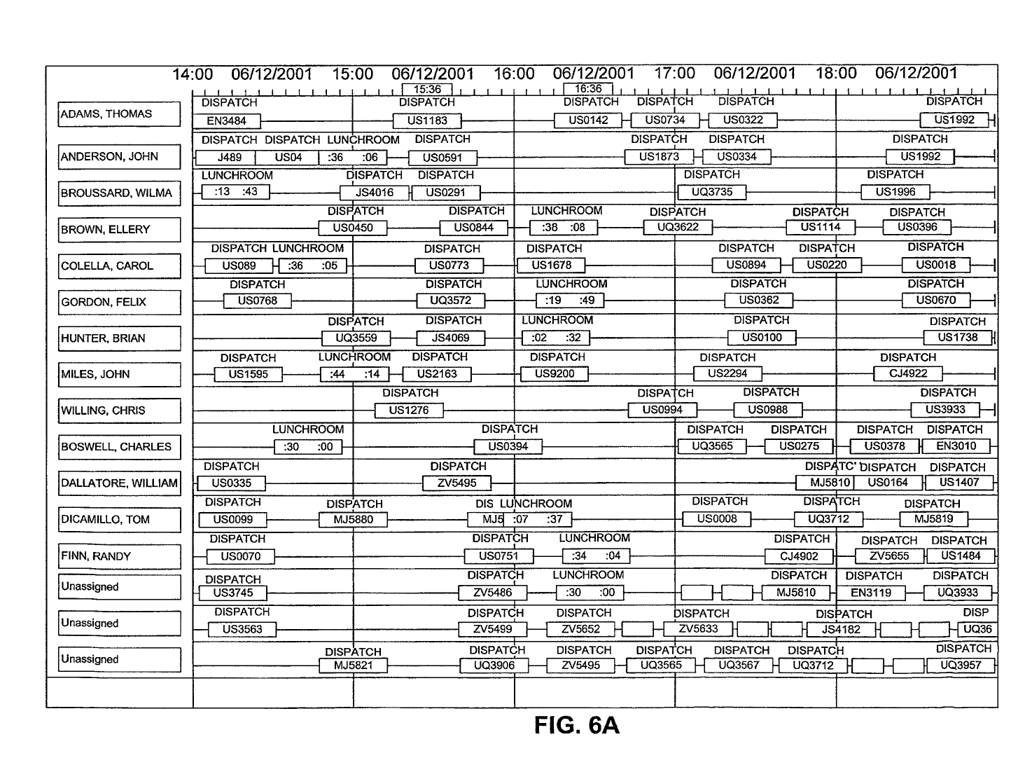

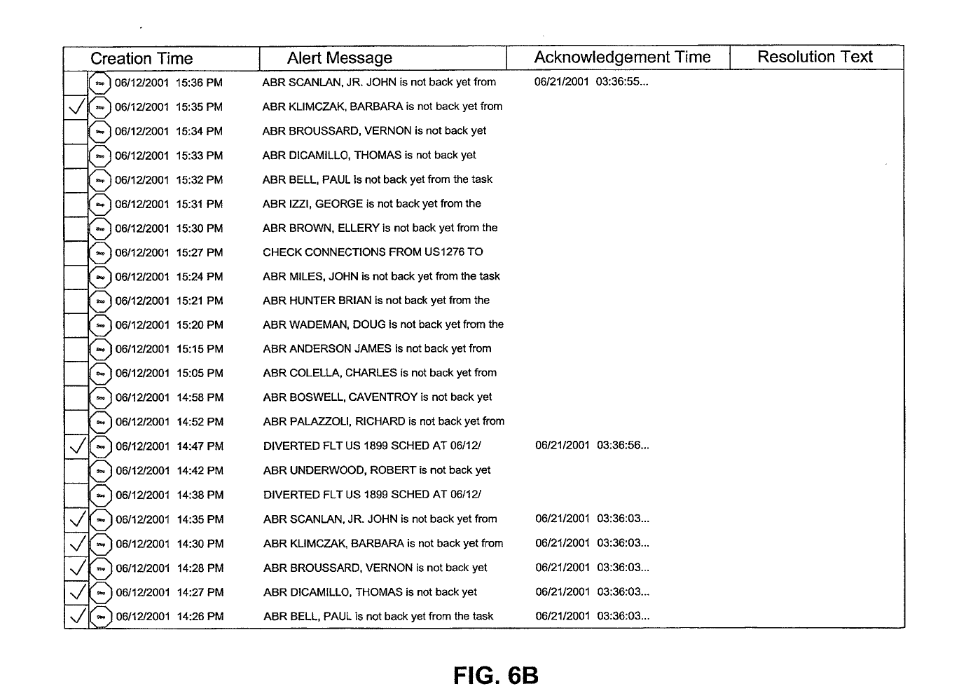

After the LRS has detected the event, it will respond according to the new information. For example, if the LRS is a flight operating system, the system may use the information automatically to reschedule ground crew depending on the contents of the new information. FIGS. 6a and 6b show a flight operating system control board. With information that a flight has been delayed an hour, the flight operating system can reschedule the ground crew according to this new information. Other examples include the following: a flight operating system may receive notice of an event and reschedule passengers who miss a connecting flight; a catering system may receive notice of an event and automatically send notice that a vegetarian meal needs to be transferred to a different flight; a fueling system may receive notice of an event and automatically send notice that additional fuel is necessary to meet the demand; and an airline gate agent may receive notice of an event and send notice that special assistance is required for a transferred passenger.

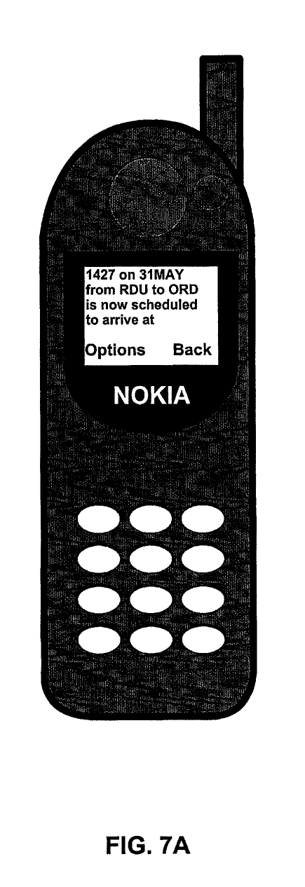

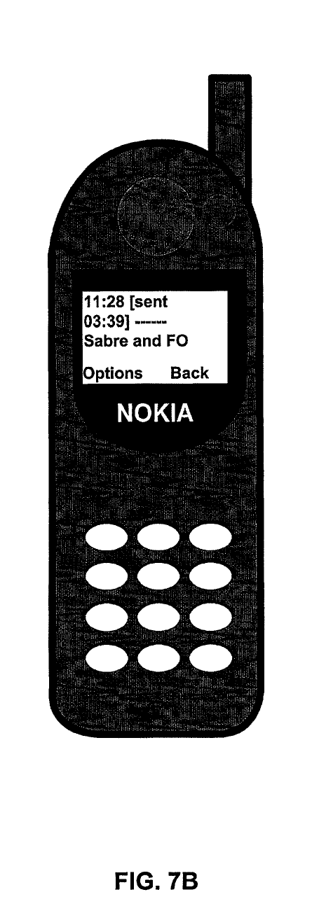

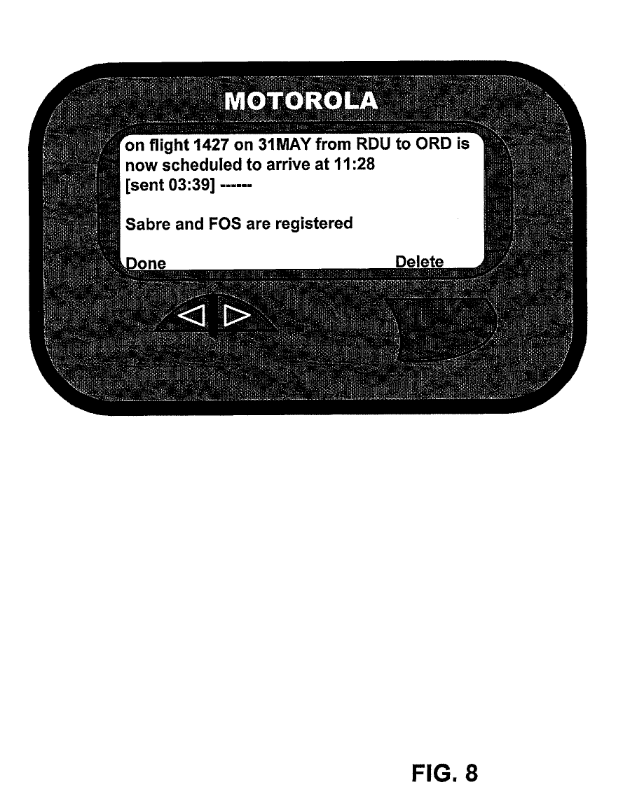

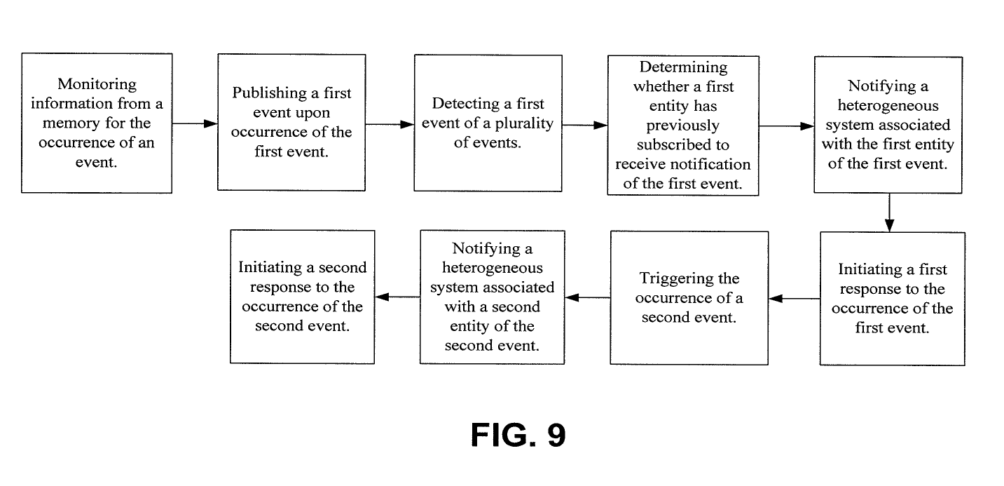

If the LRS received a request from an N-LRS, the LRS will notify the NLRS that an event occurred (step 325). The LRS will transmit notification of the event and any individualized information relevant to the N-LRS. For example, an individual may have requested notification of changes in a flight schedule, which will be the information the N-LRS receives. If the N-LRS requested notification of, for example, rebooking information, the individual will receive notification of such. In addition, the individual may specify the notification device—for example, cellular telephone, pager, email, fax, etc. Accordingly, the individual will be notified via the specified device. FIGS. 7a, 7b, and 8 demonstrate a possible screen view of notification received via cellular telephone or electronic paging device, respectively.

Further, the LRS may transmit requested information either serially or in parallel. For example, the LRS may transmit information to a passenger that he or she has been rebooked on a different flight at the same time it transmits an updated ground crew schedule to a flight operator accounting for changes in flight schedules.

A network and methods to distribute travel information in a manner consistent with the present invention thus facilitates the distribution of changes to travel information to the user. By providing a network and using a publish-subscribe paradigm, entities may continuously receive notification of events as they occur. In addition, entities can subscribe to a component on the network and automatically receive notification of events without initiating additional requests.

It will be recognized by one skilled in the art that while this description discusses the invention in terms of changes in travel information, that the scope of this invention also includes other changes, including but not limited to changes in hotel or car rental reservations, bus, train, or boat reservations, delays in mass transit, or road closures.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. For example, the described implementation includes software but the present invention may be implemented as a combination of hardware and software or in hardware alone. The invention may be implemented with both object-oriented and nonobject-oriented programming systems. Additionally, although aspects of the present invention are described as being stored in memory, one skilled in the art will appreciate that these aspects can also be stored on other types of computer-readable media, such as secondary storage devices, like hard disks, floppy disks, or CD-ROM; a carrier wave from the Internet or other propagation medium; digital or optical signals; or other forms of RAM or ROM. The scope of the invention is defined by the claims and their equivalents.

What is claimed is:

1. A method for notifying travelers of changes in travel information in an integrated event notification system, the method comprising:
monitoring travel information for changes and publishing a change in travel information upon occurrence of the change;
detecting when a change in travel information has been published based upon a previous subscription to receive notification of changes in travel information;
automatically initiating the re-accommodation of travel for at least one traveler in response to detecting the change in travel information and without awaiting a request from the at least one traveler; and
notifying the at least one traveler of the re-accommodation, the at least one traveler having previously subscribed to receive notification of changes in travel information affecting the traveler's itinerary.

2. The method of claim 1, wherein detecting comprises detecting when a flight for the at least one traveler has been cancelled, delayed, or rerouted.

3. The method of claim 2, wherein automatically initiating the re-accommodation of travel comprises rebooking the at least one traveler on a different flight.

4. The method of claim 1, further comprising receiving a request from the traveler for notification of the re-accommodation.

5. The method of claim 1, wherein automatically initiating the re-accommodation comprises notifying an airline operating system of the change in travel information.

6. A computer-readable medium containing instructions for controlling a data processing system to perform a method of notifying travelers of changes in travel information, said method comprising the steps of:
monitoring travel information for changes and publishing a change in travel information upon occurrence of the change;
detecting when a change in travel information has been published based upon a previous subscription to receive notification of changes in travel information;
automatically initiating the re-accommodation of travel for at least one traveler in response to detecting the change in travel information and without awaiting a request from the at least one traveler; and
notifying the at least one traveler of the re-accommodation, the at least one traveler having previously subscribed to receive notification of changes in travel information affecting the traveler's itinerary.

7. A data processing system for notifying travelers of changes in travel information, comprising:
a source system configured to monitor travel information for changes and publish a change in travel information upon occurrence of the change; and
a receiving system configured to:
detect when a change in travel information has been published, the receiving system having previously subscribed to receive notification of changes in travel information;
automatically initiate the re-accommodation of travel for at least one traveler in response to detecting the change in travel information without awaiting a request from the at least one traveler; and
notify the at least one traveler of the re-accommodation, the at least one traveler having previously subscribed to receive notification of changes in travel information affecting the traveler's itinerary.

8. The system of claim 7, wherein the receiving system is an airline operating system.

9. The system of claim 7, wherein the receiving system is a listening-receiving system.

10. The system of claim 7, wherein the receiving system is configured to detect when a flight for the at least one traveler has been cancelled, delayed, or rerouted.

11. The system of claim 10, wherein the receiving system is configured to automatically rebook the at least one traveler on a different flight.

12. The system of claim 7, wherein the receiving system is further configured to receive a request from the traveler for notification of the re-accommodation.

13. The system of claim 12, wherein the receiving system is further configured to determine whether the receiving system has subscribed to receive notification of changes in travel information upon receiving the request.

14. The system of claim 7, wherein the receiving system is configured to notify an airline operating system of the change in travel information.

15. A method for notifying ground crew of changes in travel information in an integrated event notification system, the method comprising:
monitoring travel information for changes and publishing a change in travel information upon occurrence of the change;
detecting when a change in travel information has been published based upon a previous subscription to receive notification of changes in travel information;
automatically initiating the rescheduling of ground crew in response to detecting the published change in travel information; and
notifying the ground crew of the rescheduling.

16. The method of claim 15, wherein detecting comprises detecting when a flight has been cancelled, delayed, or rerouted, a baggage claim for a flight has changed, an arrival or a departure gate of a flight has changed, or a traveler's luggage is missing.

17. The method of claim 15, wherein automatically initiating the rescheduling of ground crew comprises rescheduling a work schedule of the ground crew.

18. A data processing system for notifying ground crew of changes in travel information, comprising:
a source system configured to monitor travel information for changes and publish a change in travel information upon occurrence of the change; and
a receiving system configured to:
detect, with a receiving system, when a change in travel information has been published, the receiving system having previously subscribed to receive notification of changes in travel information;
automatically initiate the rescheduling of ground crew in response to detecting the published change in travel information; and
notify the ground crew of the rescheduling.

19. The system of claim 18, wherein the receiving system is an airline operating system.

20. The system of claim 18, wherein the receiving system is a listening-receiving system.

21. The system of claim 18, wherein the receiving system is configured to detect when a flight has been cancelled, delayed, or rerouted, a baggage claim for a flight has changed, an arrival or a departure gate of a flight has changed, or a traveler's luggage is missing.

22. The system of claim 18, wherein the receiving system is configured to automatically reschedule a work schedule of the ground crew.
